(19) United States
(12) Patent Application Publication
(10) Pub. No.: US 2018/0203556 A1
(43) Pub. Date: Jul. 19, 2018

(54) DISPLAY CONTROL SYSTEM, DISPLAY CONTROL METHOD, AND DISPLAY DEVICE

(71) Applicant: Yuto KAREI, Tokyo (JP)

(72) Inventor: Yuto KAREI, Tokyo (JP)

(73) Assignee: Ricoh Company, Ltd., Tokyo (JP)

(21) Appl. No.: 15/862,701

(22) Filed: Jan. 5, 2018

(30) Foreign Application Priority Data
Jan. 17, 2017 (JP) 2017-006010

(51) Int. Cl. G06F 3/041; G06F 3/0354

(52) U.S. Cl. CPC G06F 3/0412; G06F 3/0416; G06F 3/03545

(57) ABSTRACT

According to embodiments, a display control system includes: circuitry configured to: detect a user operation meant for updating a first screen; update, in response to updating of the first screen, a second screen according to contents of the first screen; and determine, when the circuitry detects the user operation, whether or not difference between a first timing, at which the user operation is detected, and a second timing, which corresponds to timing at which the circuitry detected the user operation in previous instance, is exceeding a setting time period that is set in advance, wherein, when the circuitry determines that the difference is equal to or smaller than the setting time period, the circuitry does not update the second screen.

### CROSS-REFERENCE TO RELATED APPLICATIONS

The present application claims priority under 35 U.S.C. § 119 to Japanese Patent. Application No. 2017-006010, filed on Jan. 17, 2017. The contents of which are incorporated herein by reference in their entirety.

### BACKGROUND OF THE INVENTION

### 1. Field of the Invention

The present invention relates to a display control system, a display control method, and a display device.

### 2. Description of the Related Art

In recent years, terminal devices such as tablet computers and electronic blackboards that function as digital screen display media have become popular, and there has been an increase in the case examples in which such terminal devices are introduced in business enterprises and schools. Moreover, with the use of such terminal devices, storing a variety of information and application of the stored information is being considered. For example, storing and utilizing the screens displayed on an electronic blackboard is being considered, storing and utilizing the information such as the characters drawn on the screen using an electronic blackboard pen is being considered, and storing and utilizing the screen in which the characters have been drawn is being considered.

For example, in Japanese Unexamined Patent Application Publication No. 2015-041373, a display control system is disclosed in which an electronic blackboard and a terminal device are connected via a connection box, and images sent from the terminal device are made sharable using the electronic blackboard. In such a display control system, for example, either every time an event is generated due to a drawing operation with respect to an electronic blackboard or at a relatively short time interval (an interval of few tens of milliseconds), the image of the screen of the electronic blackboard is captured and stored. For example, the screen of the terminal device is updated with the stored images in chronological order, so that the drawing operations performed by the user with respect to the electronic blackboard can be replicated on the screen of the terminal device on a substantially real-time basis.

However, as far as the user of the terminal device is concerned, when a drawing operation with respect to the electronic blackboard is to be replicated in the terminal device, the screens during the entire process of the drawing operation are not often required. Hence, there is a possibility that eventually unnecessary images get stored. Besides, the point-by-point updating of the screen of the terminal device might be annoying to the user.

In view of the issues mentioned above, there is a need to enable updating of the screen, which is performed in response to user operations, at more appropriate timings.

### SUMMARY OF THE INVENTION

According to exemplary embodiments of the present invention, there is provided a display control system comprising: circuitry configured to: detect a user operation meant for updating a first screen.; update, in response to updating of the first screen, a second screen according to contents of the first screen; and determine, when the circuitry detects the user operation, whether or not difference between a first timing, at which the user operation is detected, and a second timing, which corresponds to timing at which the circuitry detected the user operation in previous instance, is exceeding a setting time period that is set in advance, wherein, when the circuitry determines that the difference is equal to or smaller than the setting time period, the circuitry does not update the second screen.

Exemplary embodiments also provide a display control method comprising: detecting a user operation meant for updating a first screen; controlling that includes updating, in response to updating of the first screen, a second screen according to contents of the first screen; and determining that, when the user operation is detected at the detecting, includes determining whether or not difference between a first timing, at which the user operation is detected, and a second timing, which corresponds to timing at which the user operation was detected at the detecting in previous instance, is exceeding a setting time period that is set in advance, wherein, when it is determined at the determining that the difference is equal to or smaller than the setting time period, the controlling includes not updating the second screen.

Exemplary embodiments also provide a display device comprising: circuitry configured to: detect a user operation meant for updating a first screen; obtain, in response to updating of the first screen, image of the first screen; and determine, when the circuitry detects the user operation, whether or not difference between a first timing, at which the user operation is detected, and a second timing, which corresponds to timing at which the circuitry detected the user operation in previous instance, is exceeding a setting time period that is set in advance, wherein, when the circuitry determines that the difference is equal to or smaller than the setting time period, the circuitry does not obtain the image.

### BRIEF DESCRIPTION OF THE DRAWINGS

FIG. 1 is a block diagram illustrating an exemplary display control system implementable in a first embodiment;

FIG. 2 is a sequence diagram illustrating an exemplary sequence of sending a captured image as implementable in the first embodiment;

FIG. 3 is a block diagram illustrating an exemplary hardware configuration of an electronic blackboard implementable in the first embodiment;

FIG. 4 is a block diagram illustrating an exemplary hardware configuration of a server device that is implementable in the first embodiment;

FIG. 5 is a block diagram illustrating an exemplary hardware configuration of a terminal device that is implementable in the first embodiment;

FIG. 6 is a functional block diagram of an example meant for explaining the functions of the electronic blackboard according to the first embodiment;

FIG. 7 is a functional block diagram of an example meant for explaining the functions of the server device that is implementable in the first embodiment;

FIG. 8 is a functional block diagram of an example meant for explaining the functions of the terminal device that is implementable in the first embodiment;

FIG. 9 is a diagram illustrating an example of the display on the screen of the electronic blackboard that is implementable in the first embodiment;

FIG. 10 is a diagram illustrating an example of the display on the screen of the electronic blackboard that is implementable in the first embodiment;

FIG. 11 is a diagram illustrating an example of the display on the screen of the electronic blackboard that is implementable in the first embodiment;

FIG. 12 is a diagram illustrating an example of the display on the screen of the electronic blackboard that is implementable in the first embodiment;

FIG. 13 is a diagram for explaining the drawing of images on the screen of the electronic blackboard using a dedicated pen;

FIG. 14 is a diagram that schematically illustrates an example of the screens of the electronic blackboard and the terminal device in the case in which, every time a drawing event is generated, the electronic blackboard sends a captured image of the screen thereof so that the screen of the terminal device gets updated;

FIG. 15 is a flowchart for explaining an example of the control performed regarding the screen capturing in a first operation mode according to the first embodiment;

FIG. 16 is a diagram that schematically illustrates an example of the screens of the electronic blackboard and the terminal that are updated according to the operations performed in the first embodiment;

FIG. 17 is a flowchart for explaining an example of the control performed regarding the screen capturing in a second operation mode according to the first embodiment;

FIG. 18 is illustrated an exemplary relationship between audio recording and screen capturing performed in the electronic blackboard according to the first embodiment;

FIG. 19 is a functional block diagram of an example meant for explaining the functions of an electronic blackboard according to a second embodiment;

FIG. 20 is a functional block diagram of an example meant for explaining the functions of a server device according the second embodiment;

FIG. 21 is a flowchart for explaining an example of the control performed regarding the screen capturing by the electronic blackboard according to the second embodiment; and

FIG. 22 is a flowchart for explaining an example of the operations performed in the server device according to the second embodiment.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is t understood that each specific element includes all technical equivalents that have the same function, operate in a similar manner, and achieve a similar result.

An embodiment of the present invention will be described in detail below with reference to the drawings.

Exemplary embodiments of a display control system, a display control method, a display device, a computer program product, and an information processing device are described below in detail with reference to the accompanying drawings.

### First Embodiment

Display Control System Implementable in First Embodiment

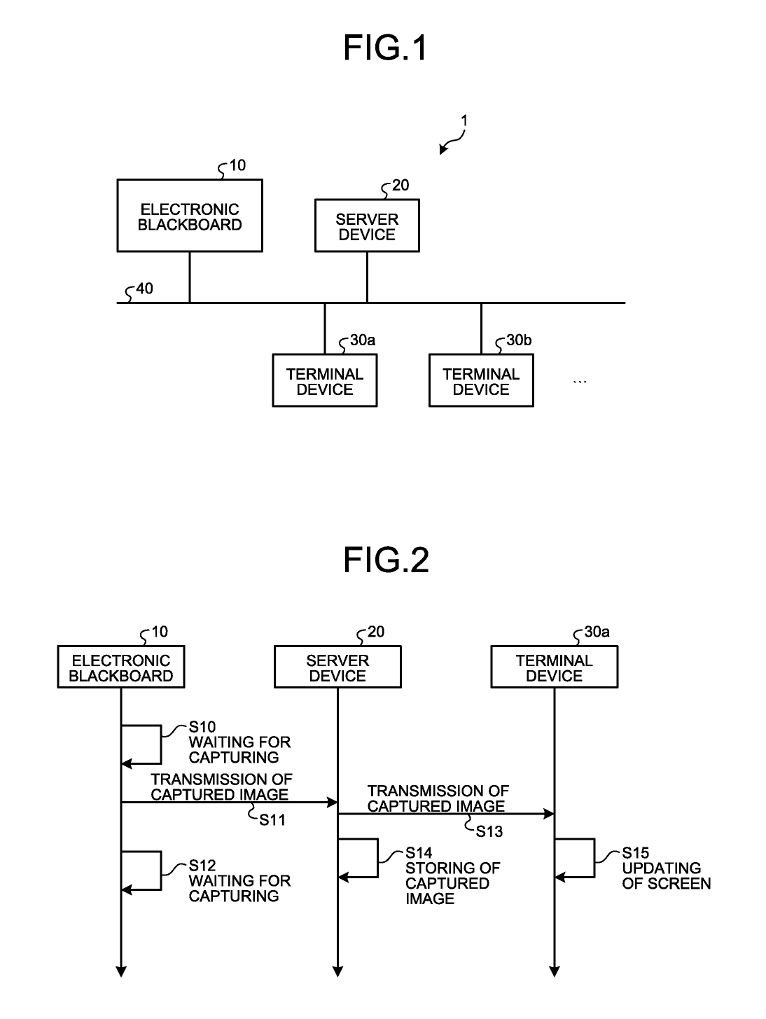

In FIG. 1 is illustrated an exemplary display control system implementable in a first embodiment. With reference to FIG. 1, a display control system 1 includes an electronic blackboard 10, a server device 20, and one or more terminal devices 30a, 30b, and so on; and all constituent elements are connected to a network 40.

The electronic blackboard 10 includes a large-sized. touch-sensitive panel in which a display device and an input device are provided in an integrated manner; and obtains, as image data, information that is input on the touch-sensitive panel (written on the blackboard) using a dedicated pen, and displays a screen according to the obtained image data. Moreover, the electronic blackboard 10 can store and output the obtained image data.

The server device 20 manages the information devices connected to the network 40, and controls the communication between the electronic blackboard 10 and the terminal devices 30a, 30b, and so on. The terminal devices 30a, 30b, and so on are mobile devices such as personal computers or smartphones, and are connected to the network 40 using wired communication or wireless communication.

In the display control system 1 configured in the manner described above, image data corresponding to the information written on the electronic blackboard 10 can be sent to the terminal devices 30a, 30b, and so on via the network 40. For example, the electronic blackboard 10 captures the displayed screen according to the information written on the blackboard; and sends image data obtained by capturing (called a captured image) to the terminal devices 30a, 30b, and so on via the network 40. Then, the terminal devices 30a, 30b, and so on can display a screen based on the image data sent from the electronic blackboard 10.

FIG. 2 is a sequence diagram illustrating an exemplary sequence of sending a captured image as implementable in the first embodiment. With reference to FIG. 2, the same constituent elements as illustrated in FIG. 1 are referred to by the same reference numerals and their detailed explanation is not repeated. Meanwhile, the terminal devices 30a, 30b, and so on can be implemented using an identical configuration. Hence, in the following explanation, unless otherwise specified, the explanation is given about the terminal device 30a as a representative of the terminal devices 30a, 30b, and so on.

The electronic blackboard 10 performs screen capturing according to the events generated based on the operations performed with respect to the electronic blackboard 10. Examples of an event that leads to screen capturing include an event generated at regular intervals and an event generated corresponding to an input with respect to the touch-sensitive panel. The electronic blackboard 10 waits for the generation of an event that leads to image capturing (Step S10). The electronic blackboard 10 captures the screen in response to the generation of the event, and sends the captured image to the server device 20 via the network 40 (Step S11). Then, the electronic blackboard 10 waits for the generation of the next event that leads to screen capturing (Step S12).

Upon receiving a captured image from the electronic blackboard 10, the server device 20 sends that captured image to the terminal device 30a via the network 40 (Step S13). Moreover, the server device 20 can store the captured image, which is received from the electronic blackboard 10, in a memory medium provided in the server device 20 (Step S14). Upon receiving the captured image, which has the screen of the electronic blackboard 10 captured therein, from the server device 20; the terminal device 30a updates the image on the screen thereof with the captured image that is received (Step S15).

As a result of the operations described above, the screen of the terminal device 30a gets updated with the captured image that has the screen of the electronic blackboard 10 captured therein. As a result, the screen of the electronic blackboard 10 can be reflected in the screen of the terminal device 30a.

Configuration of Various Devices Implementable in First Embodiment

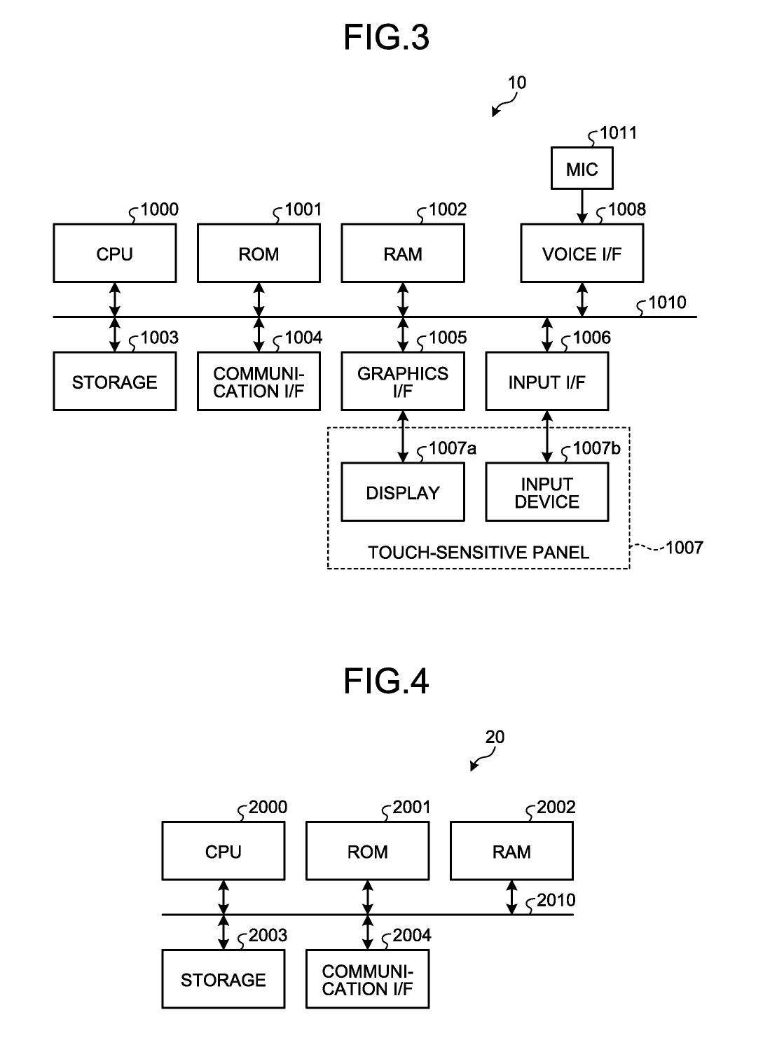

In FIG. 3 is illustrated an exemplary hardware configuration of the electronic blackboard 10 implementable in the first embodiment. With reference to FIG. 3, the electronic blackboard 10 includes a central processing unit (CPU) 1000, a read only memory. (ROM) 1001, a random access memory (RAM) 1002, a storage 1003, a communication interface (I/F) 1004, a graphics I/F 1005, an input I/F 1006, and a voice I/F 1008 that are communicably connected to each other by a bus 1010. Thus, the electronic blackboard 10 includes the CPU 1000, the ROM 1001, and the RAM 1002; and can be regarded as a computer.

The electronic blackboard 10 includes a display 1007a and an input device 1007b. The display 1007a and the input device 1007b are configured in an integrated manner and constitute what is called a touch-sensitive panel 1007. In the following explanation, the input device 1007b is assumed to be capable of receiving the input via a pen-shaped tool that is provided exclusively for the electronic blackboard 10 (hereinafter, called a dedicated pen). However, that is not limited to this example. Alternatively, the input device 1007b can be configured to be further capable of receiving input via the touch of a finger.

The storage 1003 is configured with a hard disk drive or a nonvolatile semiconductor memory, and is used to store various computer programs and data meant for the operations of the CPU 1000. The ROM 1001 is used to store in advance computer programs and data meant for, for example, the activation and the operations of the electronic blackboard 10. The CPU 1000 follows the instructions given in the computer programs stored in the storage 1003 or the ROM 1001, utilizes the RAM 1002 as the work memory, and controls the overall operations of the electronic blackboard 10. The communication I/F 1004 follows instructions from the CPU 1000 and controls the communication performed via the network 40.

The graphics I/F 1005 converts a display control signal, which is generated by the CPU 1000 according to computer programs, into a display signal compatible to the display 1007a; and sends the display signal to the display 1007a.

For example, the graphics I/F 1005 includes a video memory (VRAM) capable of storing at least a single screen of the display 1007a in the unit of pixels. According to the display control signal, the graphics I/F 1005 generates image data in the unit of pixels for the purpose of displaying the screen, and writes the image data in that area in the video memory which corresponds to the screen. The image data equivalent to a single screen as written in the video memory is read from the video memory at a constant frequency (for example, 60 Hz), and is transferred as a display signal to the display 1007a.

The display 1007a includes, for example, a liquid. crystal display (LCD) functioning as the display device, and includes a driving circuit that drives the display device according to display signals. The input I/F 1006 converts the signal, which is output from the input device 1007b in response to, for example, a touch operation with respect to the input device 1007b, into a control signal. compatible to the CPU 1000, and outputs the control signal to the bus 1010.

In the voice I/F 1008, a microphone (MIC) 1011 is embedded for picking up a voice and outputting an analog voice signal according to the picked voice. The voice I/F 1008 receives input of the analog voice signal that is output from the microphone 1011, converts the analog voice signal into a digital voice signal, and outputs the digital voice signal to the bus 1010. Meanwhile, the microphone 1011 can be connected as an external device to the voice I/F 1008.

In FIG. 4 is illustrated an exemplary hardware configuration of the server device 20 that is implementable in the first embodiment. With reference to FIG. 4, the server device 20 includes a CPU 2000, a ROM 2001, a RAM 2002, a storage 2003, and a communication I/F 2004 that are communicably connected to each other by a bus 2010.

The storage 2003 is a memory medium configured with a hard disk drive or a nonvolatile semiconductor memory. The CPU 2000 follows the instructions given in the computer programs stored in advance in the storage 2003 or the ROM 2001, utilizes the RAM 2002 as the work memory, and controls the overall operations of the server device 20. The communication I/F 2004 follows instructions from the CPU 2000 and controls the communication performed via. the network 40.

The storage 2003 is further used to store management information regarding the information devices connected to the network 40, and to store authentication information of the users who can get connected to the network 40. Moreover, the storage 2003 can be used to store captured images that are sent from the electronic blackboard 10 and that have the screen of the electronic blackboard 10 captured therein. Meanwhile, in the example illustrated in FIG. 4, the storage 2003 is illustrated to be embedded in the server device 20. However, the configuration is not limited to this example. Alternatively, for example, the storage 2003 can be an external memory device that is connected to the server device 20 either directly or via the network 40.

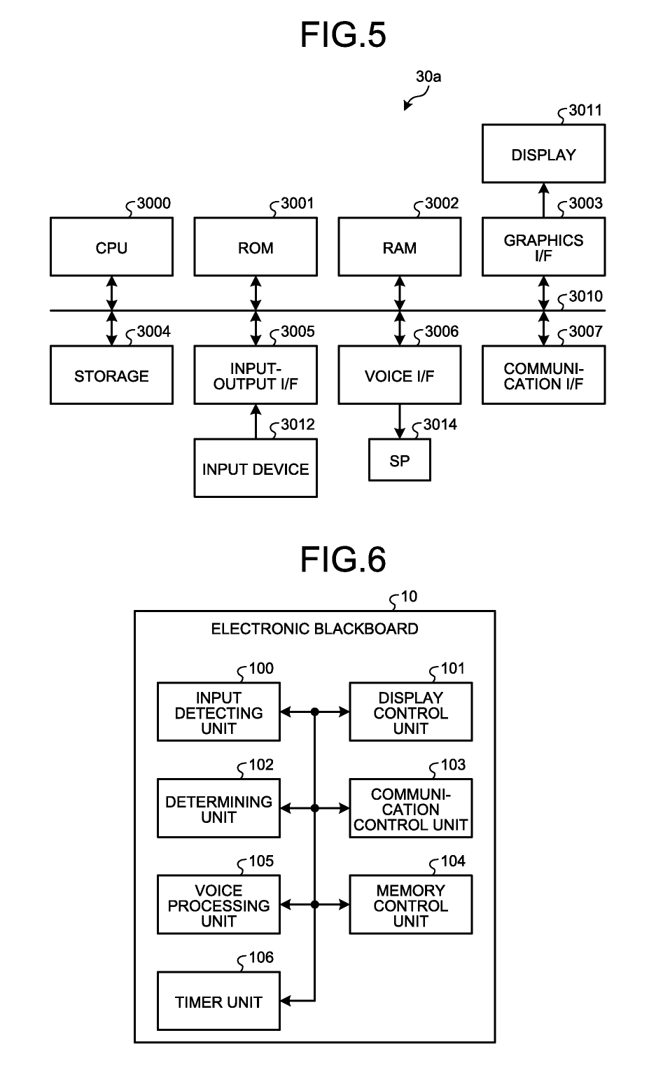

FIG. 5 is illustrated an exemplary hardware configuration of the terminal device 30a that is implementable in the first embodiment. The other terminal devices such as the terminal device 30b can be implemented. using an identical configuration to the configuration of the terminal device 30a. Hence, that explanation is not given. With reference to FIG. 5, the terminal device 30a includes a CPU 3000, a ROM 3001, a RAM 3002, a graphics I/F 3003, a storage 3004, an input-output I/F 3005, a voice I/F 3006, and a communication I/F 3007 that are communicably connected to each other by a bus 3010.

The storage 3004 is a memory medium for storing data in a nonvolatile manner, and can be a hard disk drive or a flash memory. The storage 3004 is used to store computer programs and data meant for the operations of the CPU 3000.

For example, the CPU 3000 follows the instructions given in the computer programs stored in advance in the ROM 3001 or the storage 3004, utilizes the RAM 3002 as the work memory, and controls the overall operations of the terminal device 30a. The graphics I/F 3003 generates a display signal, which is compatible to a display 3011, based on the display control signal generated by the CPU 3000 according to the computer programs. The display 3011 displays a screen according to the display signal provided from the graphics I/F 3003.

The input-output I/F 3005 transmits data to and receives data from external devices. Herein, for example, a universal serial bus (USB) can be used as the input-output I/F 3005. In this example, an input device 3012 is connected to the input-output I/F 3005 for the purpose of receiving user input. Examples of the input device 3012 include a keyboard and a pointing device such as a mouse. The communication I/F 3007 follows instructions from the CPU 3000 and controls the wired communication or the wireless communication performed with the network 40.

The voice I/F 3006 has a speaker (SP) 3014 connected thereto for converting analog voice signals into voice and outputting the voice. For example, the voice I/F 3006 converts digital voice signals, which are provided from the CPU 3000, into analog voice signals, and can provide the analog voice signals to the speaker 3014.

FIG. 6 is a functional block diagram of an example meant for explaining the functions of the electronic blackboard 10 according to the first embodiment. With reference to FIG. 6, the electronic blackboard 10 includes an input detecting unit 100, a display control unit 101, a determining unit 102, a communication control unit 103, a memory control unit 104, a voice processing unit 105, and a timer unit 106.

The input detecting unit 100, the display control unit 101, the determining unit 102, the communication control unit 103, the memory control unit 104, the voice processing unit 105, and the timer unit 106 are implemented using the computer programs running in the CPU 1000. However, that is not the only possible case. Alternatively, some or all of the input detecting unit 100, the display control unit 101, the determining unit 102, the communication control unit 103, the memory control unit 104, the voice processing unit 105, and the timer unit 106 can be configured using hardware circuits that operate in cooperation with each other.

The input detecting unit 100 detects an input performed with respect to the touch-sensitive panel 1007 (the input device 1007b ), and generates an event according to the detected contents. For example, the input detecting unit 100 detects, as an input with respect to the touch-sensitive panel 1007, a touch of a dedicated pen of the electronic blackboard 10 with respect to the touch-sensitive panel 1007. However, that is not the only possible case. Alternatively, the input detecting unit 100 can be configured to detect, as an input, a touch of a finger with respect to the touch-sensitive panel 1007.

The display control unit 101 generates a display control signal for the purpose of displaying a screen on the display 1007a. Moreover, the display control unit 101 obtains (captures) the image of the screen, which is being displayed on the display 1007a, as a captured image at a predetermined timing. For example, in response to a capture instruction, the display control unit 101 reads, from the video memory in the graphics I/F 1005, the image data of a single screen in the unit of pixels; and thus captures the screen.

Furthermore, the display control unit 101 generates a display control signal according to an event generated by the input detecting unit 100, and updates the screen displayed on the display 1007a. For example, when a display control signal is generated in response to an event, the display control unit 101 sends the display control signal to the graphics I/F 1005. Then, according to the display control signal sent by the display control unit 101, the graphics I/F 1005 updates the contents in the video memory with the generated image data.

The determining unit. 102 determines, based on a predetermined condition, whether or not to capture the screen displayed on the display 1007a. For example, based on the event generated by the input detecting unit 100 or based on time information output from the timer unit 106 (described later), the determining unit 102 determines whether or not to capture the screen.

The communication control unit 103 controls the communication I/F 1004 and performs communication via the network 40. The memory control unit 104 controls the storing of data in the storage 1003 and controls the reading of data from the storage 1003.

The voice processing unit 105 performs voice processing, such as audio recording of digital voice signals output from the voice I/F 1008, according to the event generated by the input detecting unit 100. For example, the voice processing unit 105 performs audio recording by storing, in the storage 1003, voice data that was picked up by the microphone 1011 and converted into digital voice signals by the voice I/F 1008. The voice data can then be sent to the server device 20 via the network 40.

The timer unit 106 measures the amount of time and outputs information indicating the measured amount of time as time information.

The computer program meant for implementing the functions of the electronic blackboard 10 (called an electronic blackboard program) is recorded as an installable file or an executable file in a computer-readable recording medium such as a compact disk (CD), a flexible disk (FD), or a digital versatile disk (DVD). However, that is not the only possible case. Alternatively, the computer program can be stored in a downloadable manner in a computer connected to a network such as the Internet. Still alternatively, the computer program can be distributed via a network such as the Internet.

The electronic blackboard program contains modules of the abovementioned constituent elements (the input detecting unit 100, the display control unit 101, the determining unit 102, the communication control unit 103, the memory control unit. 104, the voice processing unit 105, and the timer unit 106). As far as the actual hardware is concerned, the CPU 1000 reads the electronic blackboard program from a memory medium such as the storage 1003 and executes it, so that the abovementioned constituent elements are loaded in a main memory device and the input detecting unit 100, the display control unit 101, the determining unit 102, the communication control unit 103, the memory control unit 104, the voice processing unit 105, and the timer unit 106 get generated in the main memory device.

However, that is not the only possible case. Alternatively, the electronic blackboard program can contain modules of at least the input detecting unit 100, the display control unit 101, and the determining unit 102 from among the abovementioned constituent elements. In that case, the communication control unit 103, the memory control unit 104, the voice processing unit 105, and the timer unit 106 can be installed in advance in the electronic blackboard 10 as modules for implementing the fundamental functions of the electronic blackboard 10. The input detecting unit 100, the display control unit 101, and the determining unit 102 perform operations in cooperation with the communication control unit 103, the memory control unit 104, the voice processing unit 105, and the timer unit 106; and implement various functions of the electronic blackboard 10.

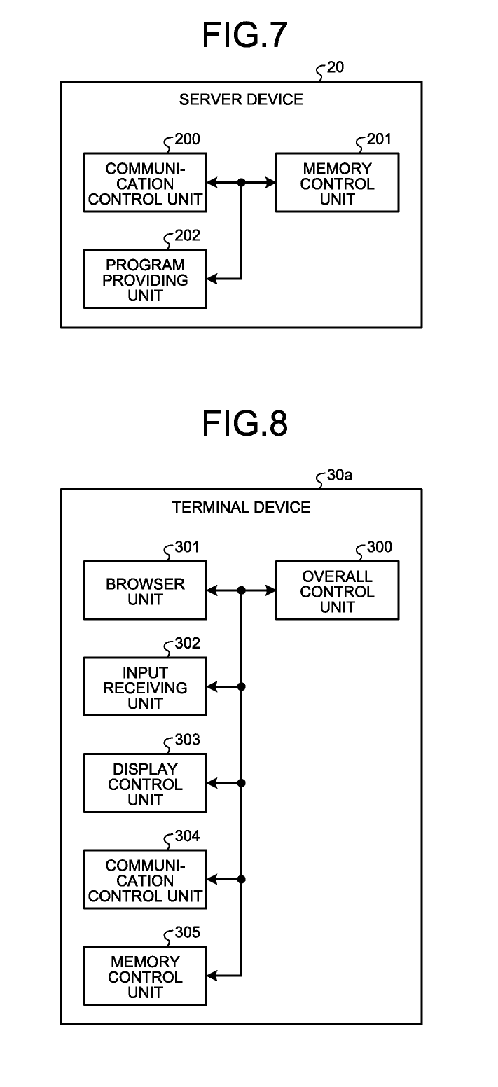

FIG. 7 is a functional block diagram of an example meant for explaining the functions of the server device 20 that is implementable in the first embodiment. With reference to FIG. 7, the server device 20 includes a communication control unit 200, a memory control unit 201, and a program providing unit 202. The communication control unit 200, the memory control unit 201, and the program providing unit 202 are implemented using the computer programs running in the CPU 2000. However, that is not the only possible case. Alternatively, some or all of the communication control unit 200, the memory control unit 201, and the program providing unit 202 can be configured using hardware circuits that operate in cooperation with each other.

The communication control unit 200 controls the communication I/F 2004 and performs communication via the network 40. The memory control unit 201 controls the storing of data in the storage 2003 and controls the reading of data from the storage 2003.

The program providing unit 202 provides, to the terminal device 30a, the computer programs enabling the terminal device 30a to implement the functions of the display control system 1 according to the first embodiment. For example, the program providing unit 202 has the function of a web server and, in response to an access from the terminal device 30a using the HTTP (which stands for HyperText Transfer Protocol), sends, to the terminal device 30a, a computer program that is stored in the storage 2003 and that is written based on, for example, the HTML (which stands for HyperText Markup Language).

FIG. 8 is a functional block diagram of an example meant for explaining the functions of the terminal device 30a that is implementable in the first embodiment. With reference to FIG. 8, the terminal device 30a includes an overall control unit 300, a browser unit 301, an input receiving unit 302, a display control unit 303, a communication control unit 304, and a memory control unit 305.

The overall control unit. 300, the browser unit 301, the input receiving unit 302, the display control unit 303, the communication control unit 304, and the memory control unit 305 are implemented using the computer programs running in the CPU 3000. However, that is not the only possible case. Alternatively, some or all of the overall control unit. 300, the browser unit 301, the input receiving unit 302, the display control unit 303, the communication control unit 304, and the memory control unit 305 can be configured using hardware circuits that operate in cooperation with each other.

The overall control unit 300 controls the overall operations of the terminal device 30a. The input receiving unit 302 receives input information according to the operations performed with respect to the input device 3012 of the terminal device 30a. The display control unit 303 generates a display signal according to the display control information. The communication control unit 304 controls the communication I/F 3007 and performs communication via the network 40. The memory control unit 305 controls the storing of data in the storage 3004 and controls the reading of data from the storage 3004.

The browser unit 301 has the function of a browser application program for reading files written in the HTML and performing predetermined operations. For example, the browser unit 301 reads HTML files according to a specified URL, generates display control information according to the read HTML files, and sends the generated display control information to the display control unit 303. Moreover, the browser unit 301 performs operations according to the input information received by the input receiving unit 302.

Example of Display on Electronic Blackboard Implementable in First Embodiment

Given below is a brief explanation of an example of the display on the screen of the electronic blackboard 10 that is implementable in the first embodiment.

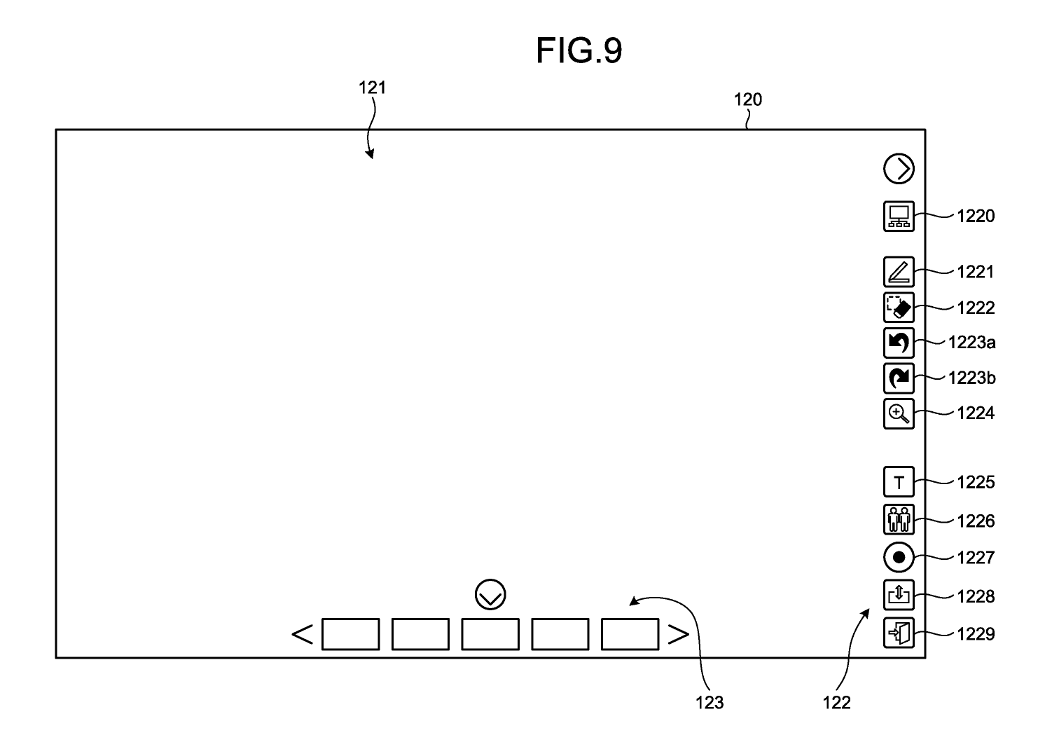

In FIGS. 9 to 12 is illustrated an example of the display on the screen of the electronic blackboard. 10 that is implementable in the first embodiment. Under the control of the display control unit 101, the electronic blackboard 10 displays a screen 120 illustrated in FIGS. 9 to 12 on the display 1007a of the touch-sensitive panel 1007. Moreover, the electronic blackboard 10 uses the input detecting unit 100 and detects an input performed using a dedicated pen with respect to the input device 1007b according to the screen 120 displayed on the display 1007a.

Given below is the brief explanation of the operation modes of the electronic blackboard 10 according to the first embodiment. The electronic blackboard 10 according to the first embodiment includes, as the operation modes, two modes, namely, a first operation mode in which the drawing done using a dedicated pen is received, and a second operation mode in which the drawing is not received. In the first operation mode as well as the second operation mode, the input detecting unit 100 of the electronic blackboard 10 detects a touch of a dedicated pen with respect to the input device 1007b and obtains the coordinates touched by the dedicated pen on the input device 1007b.

In the first operation mode, for example, the input detecting unit 100 of the electronic blackboard 10 monitors a touch of a dedicated pen and, based on the variation in the coordinates at the touched positions, generates a drawing event in which drawing is done according to the locus of the touched positions. In the second operation mode, for example, when a touch of a dedicated pen is detected with respect to a button placed in a button area (described later), the input detecting unit 100 of the electronic blackboard 10 generates an event according to the button that is detected to have been touched.

In FIG. 9 is illustrated an example of the screen in the default state in which no drawing is done. With reference to FIG. 9, the screen 120 includes a drawing area 121, a button area 122, and a thumbnail area 123. The drawing area 121 is used to perform drawing according to an input performed using a dedicated pen. Of the entire area of the screen 120, the drawing area 121 is, for example, a rectangular area excluding the button area 122 and the thumbnail area 123.

In the button area 122, buttons 1220 to 1229 are provided so that functions in the screen 120 can be specified according to the operations performed using the dedicated pen. In the thumbnail area 123, thumbnail images of the screen 120, which are stored in the electronic blackboard 10, are displayed.

The input detecting unit 100 detects an operation of specifying one of the buttons 1220 to 1229 placed in the button area 122. According to the operation detected by the input detecting unit 100, the electronic blackboard 10 performs operations corresponding to the specified button from among the buttons 1220 to 1229.

The button 1220 is meant for receiving an instruction to perform settings regarding the network 40 in the electronic blackboard 10. In response to the detection by the input detecting unit 100 of an operation (for example, a touch using the dedicated pen) with respect to the button 1220, the electronic blackboard 10 displays a setting screen meant for performing connection settings regarding the network 40.

The buttons 1221 to 1224 represent a group of buttons meant for receiving operations related to the drawing area 121. The button 1221 is meant for receiving an instruction of performing drawing in the drawing area 121 using the dedicated pen. The button 1222 is meant for receiving an instruction for erasing the image drawn in the drawing area 121. The buttons 1221 and 1222 result in the switching of the operation mode of the electronic blackboard 10 between the first operation mode and the second operation mode in response to the operation.

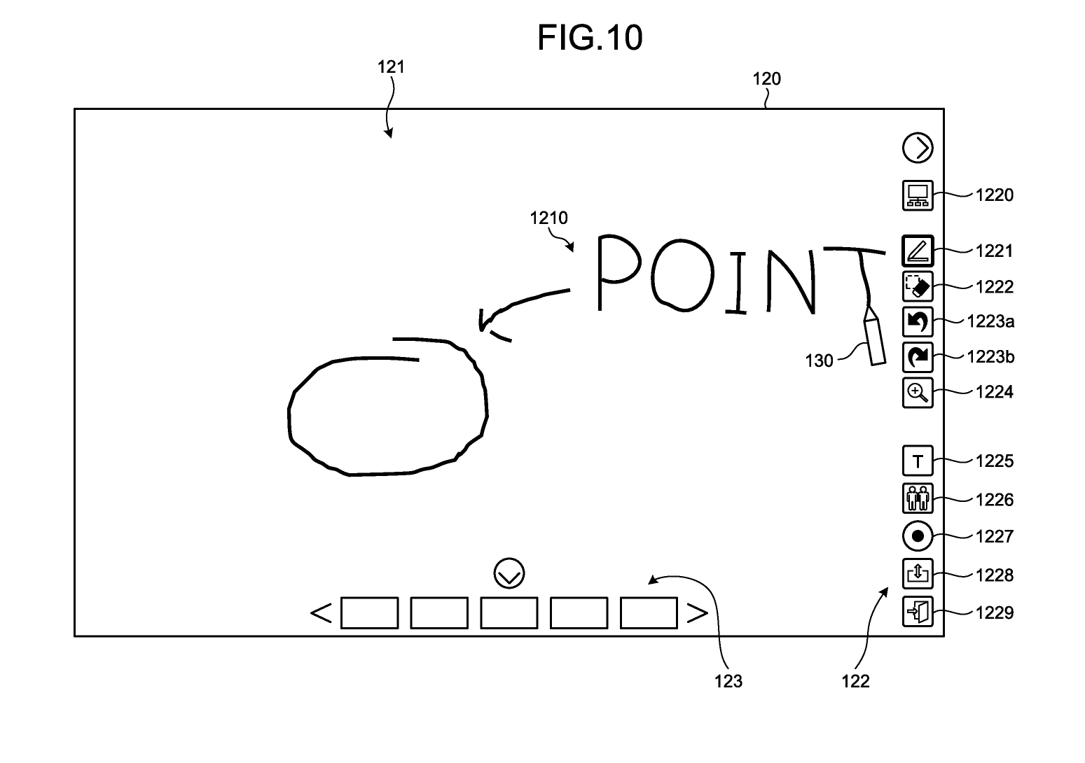

For example, in the state in which neither the button 1221 nor the button 1222 is specified as illustrated in FIG. 9, the electronic blackboard 10 is in the second operation mode. When either the button 1221 or the button 1222 is specified, the electronic blackboard 10 is in the first operation mode. In the example illustrated in FIGS. 10 to 12, the state in which the button 1221 is specified is illustrated by thickening the border of the image of the button 1221. For example, in response to the detection by the input detecting unit 100 of an operation of the button 1221 or the button 1222, the electronic blackboard 10 toggles between the first operation mode and the second operation mode.

As a specific example, in the second operation mode, when the input detecting unit 100 detects an operation of the button 1221 or the button 1222, the electronic blackboard 10 switches the operation mode to the first operation mode. Moreover, for example, in the state in which either the button 1221 or the button 1222 has been specified and thus the operation mode is set to the first operation mode, when the same button is again operated, the electronic blackboard 10 switches the operation mode from the first operation mode to the second operation mode. On the other hand, for example, if the button 1222 is operated while in the state in which the button 1221 has been specified or if the button 1221 is operated while in the state in which the button 1222 has been specified, then the electronic blackboard 10 keeps the first operation mode as it is and receives an instruction according to the operated button.

In FIG. 10 is illustrated an example in which, in the state in which the button 1221 is specified and the operation mode is set to the first operation mode, an image 1210 is drawn in the drawing area 121 using a dedicated pen 130. In the electronic blackboard 10, in the first operation mode, when one end of the dedicated pen 130 is touched to and moved over the screen 120, the image 1210 corresponding to the locus of movement of that one end of the dedicated pen 130 can be drawn (updating of the screen according to a first method).

Meanwhile, in the state illustrated in FIG. 10, if the button 1222 is operated, the display control unit 101 can erase the image 1210 that was drawn in the drawing area 121 (updating of the screen according to a second method). Herein, the display control unit 101 can erase the image 1210 at once in response to the operation of the button 1222. However, that is not the only possible case. Alternatively, the configuration can be such that, in the state in which the button 1222 is specified and the operation mode is set to the first operation mode, the display control unit 101 erases the image 1210 in a focal manner according to the locus of movement of the dedicated pen 130 having one end thereof touched to and moved over the screen 120. Meanwhile, the other end of the dedicated pen 130 can alternatively be used to erase the image 1210 in a focal manner.

Buttons 1223a and 1223b are meant to receive an undo (UNDO) instruction and a redo (REDO) instruction, respectively. For example, in the first operation mode, if the button 1223a is operated when some drawing has already been done in the drawing area 121, it becomes possible to erase the drawing done in a single continuous motion. If the button 1223b is operated after that, then it becomes possible to restore the erased drawing that was erased as a result of operating the button 1223a.

The button 1224 is meant to receive an enlargement/reduction instruction about the image drawn in the drawing area 121.

The buttons 1225 to 1229 represent a group of buttons meant to receive instructions for implementing utility functions in the electronic blackboard 10. For example, the electronic blackboard 10 can receive the operations with respect to the buttons 1225 to 1229 in the first operation mode as well as in the second operation mode.

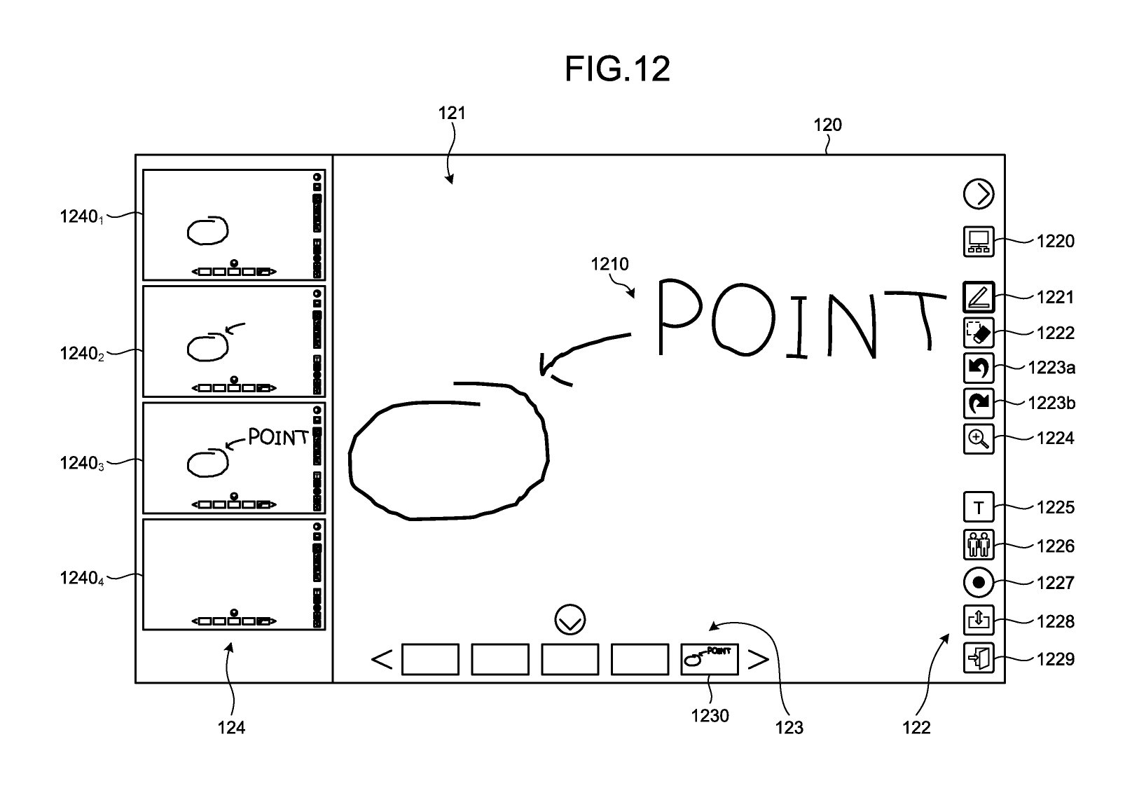

The button 1225 is meant for receiving an instruction to display a timeline area (see FIG. 12) (described later). The button 1226 is meant for switching the display on the screen 120 to a screen concerning some other computer program installed in the electronic blackboard 10. The button 1227 is meant for receiving an instruction to start audio recording of the voice picked up by the microphone 1011. When the button 1227 is operated during audio recording, the voice processing unit 105 terminates the audio recording. Moreover, the button 1227 can also be used as a trigger for screen capturing. In that case, for example, the determining unit. 102 determines whether or not to perform screen capturing based on the event generated by the input detecting unit 100 in response to the operation of the button 1227.

The button 1228 is meant for receiving an instruction to store the display contents of the screen 120. In response to the operation of the button 1228, the display control unit 101 obtains, for example, the image data stored via the graphics I/F 1005 in the area of the video memory which corresponds to the screen 120, and sends the obtained image data to the memory control unit 104. The memory control unit 104 stores the image data, which is sent from the display control unit 101, in the storage 1003. In this way, in response to the operation of the button 1228 too, the electronic blackboard 10 can capture the screen 120.

Meanwhile, the electronic blackboard 10 can send, to the server device 20, the image data of the screen 120, which is obtained in response to the operation of the button 1228, in a corresponding manner to the timing of obtaining the image data. In that case, when the image data and the timing is received from the electronic blackboard 10, the server device 20 stores the image data in a corresponding manner to the timing in the storage 2003.

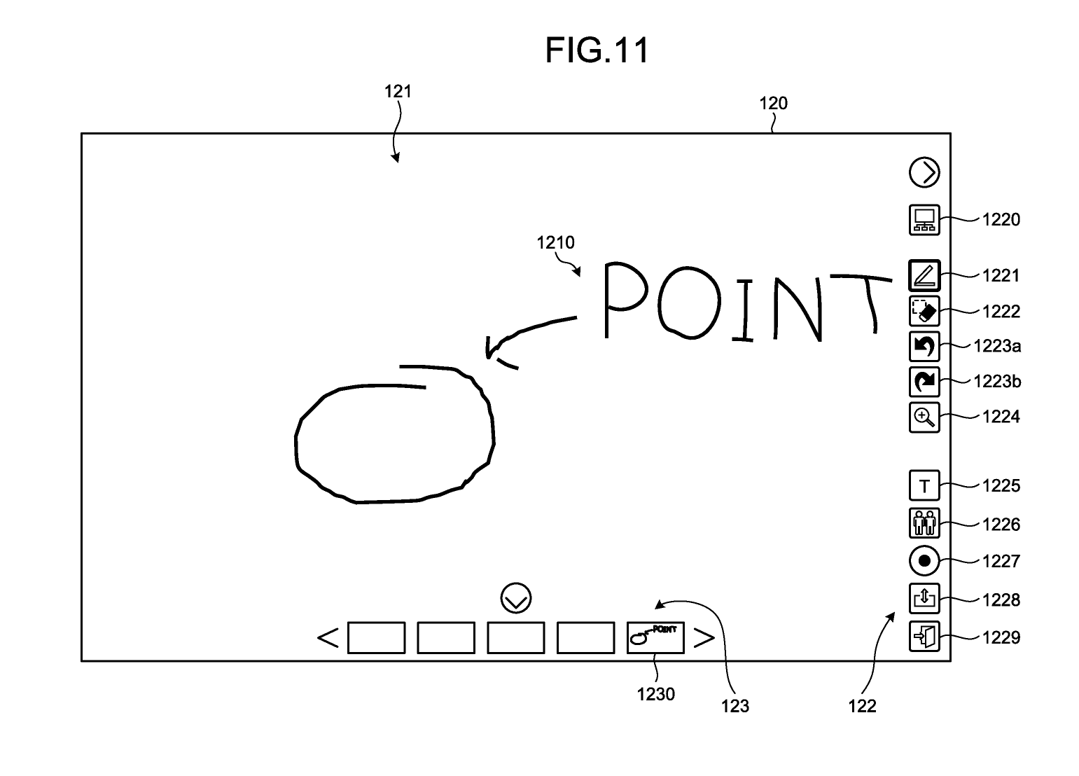

For example, the display control unit 101 can display the display contents of the screen 120, which is stored in response to the operation of the button 1228, as a thumbnail image in the thumbnail area 123. In FIG. 11 is illustrated an example in which, the thumbnail image based on the stored display contents of the screen 120 is displayed in a rightmost area 1230 from among a plurality of areas included in the thumbnail area 123. The thumbnail area 123 can be used to display, in a plurality of areas therein, thumbnail images of the display contents of the screen 120 that is stored at different timings.

Moreover, the display control unit 101 can display, in the screen 120, the image data corresponding to the thumbnail image in the specified area from among a plurality of areas included in the thumbnail area 123.

For example, when the image data is stored in the storage 1003 of the electronic blackboard 10, the display control unit 101 requests the memory control unit 104 for the image data corresponding to the specified area. The memory control unit 104 reads the requested image data from the storage 1003 and sends it to the display control unit 101. Then, the display control unit 101 updates the display on the screen 120 with the received image data.

Alternatively, for example, when the image data is stored in the storage 2003 of the server device 20, the display control unit 101 requests the server device 20 for the image data via the communication control unit 103. Then, the display control unit 101 obtains, via the communication control unit 103, the image data sent by the server device 20 in response to the request; and updates the display on the screen 120 with the obtained image data.

The button 1229 is meant for receiving an instruction to end the display of the screen 120. For example, in response to an operation of the button 1229, the display control unit 101 substitutes the image data meant for the display of the screen 120 with the image data meant for displaying the default screen (for example, the menu screen) of the electronic blackboard 10.

The electronic blackboard 10 can perform a timeline display in which the captured images, in which the screen 120 is captured, are displayed one after another in chronological order of capturing. In FIG. 12 is illustrated an example of a timeline area 124 in which the timeline display of the screen 120 is performed. For example, when the input detecting unit 100 detects an operation of the button 1225, the electronic blackboard 10 displays the timeline area 124 in the screen 120.

It is assumed that the image data in which the screen 120 is captured is stored in a corresponding manner to the capturing timing in the storage 1003 of the electronic blackboard 10. For example, in response to the operation of the button 1225, the display control unit 101 requests the memory control unit 104 for a predetermined number of sets of image data, from among the sets of image data stored in the storage 1003, that are traced back in chronological order from the image data stored at the latest timing. In response to that request, the memory control unit 104 reads the predetermined number of sets of image data from the storage 1003 and sends them to the display control unit 101.

The display control unit 101 generates reduced image data by reducing the predetermined number of sets of image data that are sent by the memory control unit 104; and displays images, which are based on the reduced image data, one after another in chronological order in the timeline area 124. In the example illustrated in FIG. 12, reduced images 1240₁, 1240₂, 1240₃, and 1240₄ that are based on four sets of image data stored in the storage 1003 are displayed one after another in the timeline area 124 with, for example, the reduced image 1240₄ representing the reduced image data corresponding to the latest image data in this example, in the reduced image 1240₄ is illustrated the state in which the contents drawn in the screen 120 have been erased.

From among the reduced images 1240₁, 1240₂, 1240₃, and 1240₄ displayed in the timeline area 124, the display control unit 101 can display, on the screen 120, the image that is based on the image data corresponding to the specified reduced image. In that case, the timeline area 124 may overlap the image that is based on the image data. Meanwhile, for example, even if the button 1226 is operated so that the display on the screen 120 is changed to a screen concerning some other computer program, the display control unit 101 can ongoingly display the timeline area 124 in the screen concerning the other computer program.

Display Control According to First Embodiment

Given below is the explanation of the display control performed according to the first embodiment. In the display control system 1 according to the first embodiment, the electronic blackboard 10 sends the image data of the screen 120 to the terminal device 30a, and the terminal device 30a updates the screen thereof according to the image data of the screen 120 as sent by the electronic blackboard 10. In the first embodiment, the timing of capturing the screen 120, which is updated according to a drawing event in the electronic blackboard 10, is controlled so as to optimize the updating of the screen in the terminal device 30a.

Meanwhile, for example, the terminal device 30a accesses the program providing unit 202 of the server device 20 from the browser unit 301 using the HTTP, and obtains the computer program (the web program) sent from the program providing unit 202. The terminal device 30a can execute the web program from the browser unit 301 and can update the screen thereof based on the screen 120 of the electronic blackboard 10.

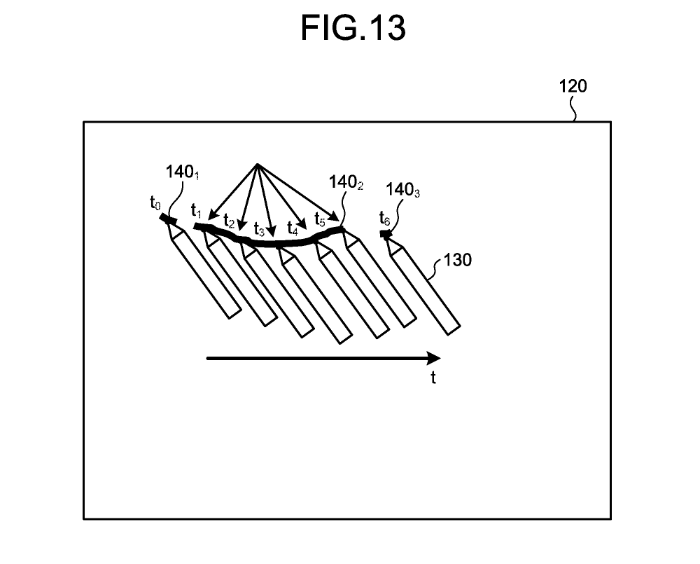

Herein, as illustrated in FIG. 13, it is assumed that images 140₁, 140₂, and 140₃ are drawn on the screen 120 of the electronic blackboard 10 using the dedicated pen 130.

More particularly, for example, the user touches the screen 120 with the dedicated pen 130 and draws the image 140₁ at a timing t₀; moves the dedicated pen 130 away from the screen 120; again touches the screen 120 with the dedicated pen 130 and moves the dedicated pen 130 on the screen 120 at a timing t1 that arrives after a certain period of time or more from the timing t₀; and draws the image 140₂ from the timing t₁ till the timing t₅. At the timing t₅, the user moves the dedicated pen 130 away from the screen 120; again touches the screen 120 with the dedicated pen 130 and moves the dedicated pen 130 on the screen 120 at a timing t₆ that arrives after a certain period of time or more from the timing t₅; and draws the image 140₃.

In the first operation mode, in response to a touch of one end of the dedicated pen 130 with respect to the screen 120, the input detecting unit 100 generates following types of drawing events, for example.

(1) When a touch of one end of the dedicated pen 130 with respect to the screen 120 is detected, a drawing event is generated.

(2) Regarding the touching position of one end of the dedicated pen 130 on the screen 120, when a change of a certain extent or more is detected in a relatively shorter period of time (for example, from few milliseconds to few tens of milliseconds), a drawing event is generated.

(3) During the generation of a drawing event, if the touch of the dedicated pen 130 with respect to the screen 120 is no more detected, the drawing event is ended (i.e., a drawing end event is generated).

In the example illustrated in FIG. 13, the input detecting unit 100 generates a drawing event at the timing t₀ and generates a drawing end event immediately after the timing t₀. Moreover, the input detecting unit 100 generates a drawing event at each of the timings t₁, t₂, t₃, and t₄; and generates a drawing end event at the timing t₅. Furthermore, the input detecting unit 100 detects a drawing event at the timing t₆ and generates a drawing end event immediately after the timing t₆.

Herein, consider a case in which, every time the input detecting unit 100 generates a drawing event or a drawing end event, the display control unit 101 of the electronic blackboard 10 captures the screen 120 and sends the captured image. Each captured image sent from the electronic blackboard 10 is sent to the terminal device 30a. via the server device 20 according to the sequence explained with reference to FIG. 2.

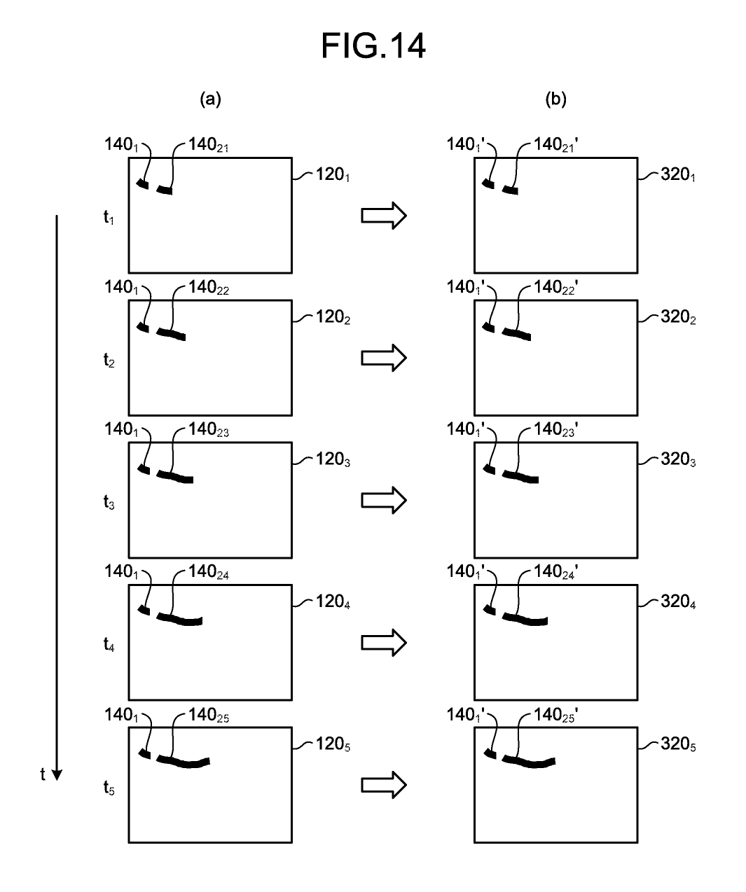

In FIG. 14 is schematically illustrated an example of the screens of the electronic blackboard 10 and the terminal device 30a in the case in which, every time a drawing event and a drawing end event is generated, the electronic blackboard 10 sends a captured image of the screen 120 so that the screen of the terminal device 30a gets updated. Herein, for the purpose of illustration, the example of the screens is given for the timings t₁ to t₅ illustrated in FIG. 13.

In a section (a) of FIG. 14, the change in the screen 120 of the electronic blackboard 10 occurring at the timings t₁ to t₅ is illustrated as screens 120₁ to 120₅. With reference to the section (a) of FIG. 14, in the screens 120₁ to 120₅, the process by which the image 140₂ gets sequentially drawn as a result of the drawing events generated at the timings t₁, t₂, t₃, t₄, and t₅ accompanying the touching and the movement of the dedicated pen 130 with respect to the screen 120 is illustrated as images 140₂₁, 140₂₂, 140₂₃, 140₂₄, and 140₂₅.

Meanwhile, at the time when the image 140₂₁ is drawn at the timing t₁, the image 140₁ is already drawn and is displayed across the screens 120₁ to 120₅.

In a section (b) of FIG. 14 is schematically illustrated an example of the screen of the terminal device 30a to which the images of the screen 120 of the electronic. blackboard 10 are transferred. In this example, for every drawing event generated in the electronic blackboard 10, a captured image is sent from the electronic blackboard 10 to the terminal device 30a. For that reason, the screen of the terminal device 30a gets updated as screens 320₁ to 320₅ corresponding to the screens 120₁ to 120₅, respectively, of the electronic blackboard 10.

As a result, as illustrated by images 140₂₁′, 140₂₂′, 140₂₃′, 140₂₄′, and 140₂₅′ in the screens 320₁ to 320₅, respectively; the process by which the image 140₂ is sequentially updated as the images 140₂₁, 140₂₂, 140₂₃, 140₂₄, and 140₂₅ in the screen 120 of the electronic blackboard 10 is reflected in the screen of the terminal device 30a.

Meanwhile, the image 140₁′ that is displayed in the screens 320₁ to 320₅ corresponds to the image 140₁ displayed in the screens 120₁ to 120₅, respectively.

Regarding the image 140₂ drawn in the screen 120 of the electronic blackboard 10, there can be times when the user who is viewing the screen of the terminal device 30a wishes to view only the result of the drawing of the image 140₂. In that case, it is possible to think that there is no need to update the screens 320₂ to 320₄ that respectively display the images 140₂₂′ to 140₂₄′ which indicate the process of drawing the image 140₂ in the screen 120 in a sequential manner.

On the other hand, it is also possible to think of capturing the screen 120 of the electronic blackboard 10 at regular time intervals (for example, after every few seconds) and updating the screen of the terminal device 30a with each captured image. However, in that case, if the time interval for capturing is set to be long, then there can also be times when the user of the terminal device 30a is not able to view the necessary images that were drawn in the electronic blackboard 10.

For that reason, in the first embodiment, a time period Tₜₕ (setting period) is set as a threshold value and the screen 120 of the electronic blackboard 10 is captured when the time interval for the drawing events exceeds the time period Tₜₕ.

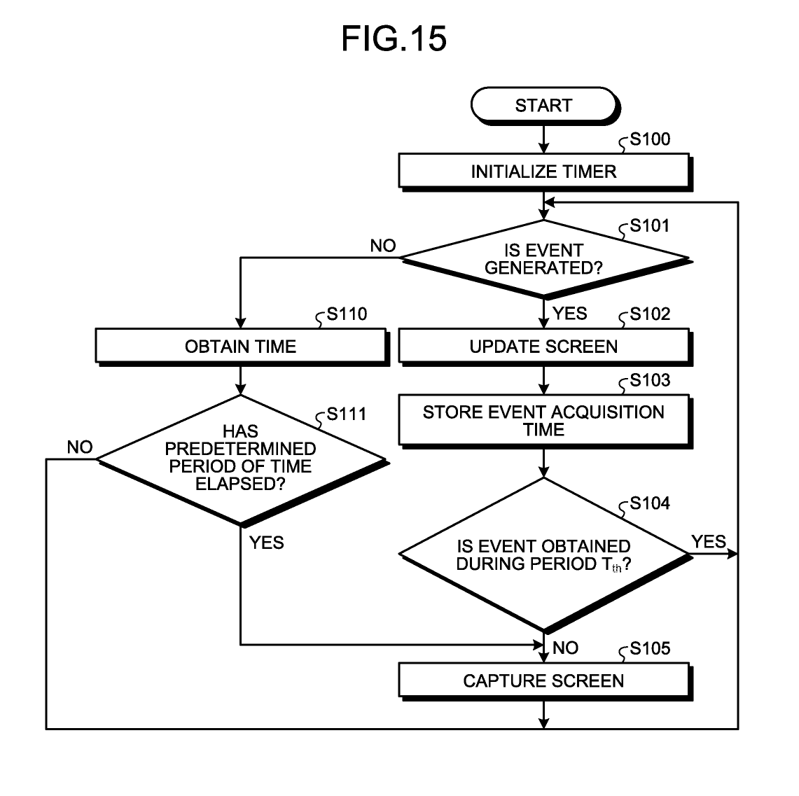

FIG. 15 is a flowchart for explaining an example of the control performed regarding the screen capturing in the first operation mode of the electronic blackboard 10. Prior to performing the operations illustrated in the flowchart in FIG. 15, the electronic blackboard 10 sets the time period Tₜₕ representing the threshold value with respect to the determining unit 102. For example, it is desirable that the time period Tₜₕ is set to such a value that the user is able to recognize the end of the drawing. Herein, the time period Tₜₕ is assumed to be set to 200 msec. Of course, the time period Tₜₕ is not limited to be equal to 200 milliseconds and can be set to some other time period (such as 150 milliseconds, 250 milliseconds, or 500 milliseconds). For example, the period Tₜₕ can be set to an appropriate time period by experiment.

The operations illustrated in the flowchart in FIG. 15 are started when the operation mode of the electronic blackboard 10 switches to the first operation mode. Step S100, the electronic blackboard 10 initializes the timer unit 106 and makes the timer unit 106 measure the amount of time from the initial value.

The operations from Step S101 onward are repeatedly performed in a loop until the operation mode of the electronic blackboard 10 switches from the first operation mode to the second operation mode.

At Step S101 implemented next, the display control unit 101 determines whether or not the input detecting unit 100 has obtained a drawing event. If it is determined that a drawing event has been obtained (Yes at Step S101), then the system control proceeds to Step S102. At Step S102, the display control unit 101 draws an image according to the drawing event obtained by the input detecting unit 100, and updates the display on the screen 120 with the image data of the drawn image.

At Step S103 implemented next, the display control unit 101 obtains an event acquisition timing, which represents the timing at which the drawing event was obtained, from the timer unit 106 and stores the event acquisition timing (a first time) For example, the display control unit 101 stores the event acquisition timing in the RAM 1002.

At Step S104 implemented next, the determining unit 102 determines whether or not a different drawing event has been obtained during the period Tₜₕ from the event acquisition timing obtained at Step S103. More particularly, at Step S101, the determining unit 102 obtains a difference Δt between the event acquisition timing obtained and stored at Step S103 of the previous loop and the event acquisition timing obtained and stored at Step S103 implemented one step before, and determines whether or not the difference At exceeds the period Tₜₕ.

If the determining unit 102 determines that the difference At is equal to or smaller than the period Tₜₕ, that is, if the determining unit 102 determines that a different drawing event has been obtained within the period Tₜₕ from the event acquisition timing obtained at Step S103 implemented one step before (Yes at Step S104), then the system control returns to Step S101. On the other hand, if the determining unit 102 determines that the difference Δt exceeds the period Tₜₕ, that is, if the determining unit 102 determines that no different drawing event has been obtained within the period Tₜₕ from the event acquisition timing obtained at Step S103 implemented one step before (No at Step S104), then the system control proceeds to Step S105.

At Step S105, the display control unit 101 captures the current screen 120 and obtains a captured image. Then, the display control unit 101 associates the timing of capturing the image to the captured image. Subsequently, according to the operation at Step S11 illustrated in FIG. 2, the display control unit 101 sends the captured image having the timing of capturing associated thereto to the server device 20, and stores the captured image having the timing of capturing associated thereto in the storage 1003, for example. When the operation at Step S105 is completed, the system control returns to Step S101.

The server device 20 sends, to the terminal device 30a, the captured image that is obtained at Step S105 and that is sent from the electronic blackboard 10 (Step S13 illustrated in FIG. 2). Upon receiving the captured image as sent from the server device 20, the terminal device 30a updates the screen thereof with the captured image that is received (Step S15 illustrated in FIG. 2).

Meanwhile, at Step S101, if it is determined that no drawing event is obtained (No at Step S101), then the system control proceeds to Step S110. At Step S110, the determining unit 102 obtains the current time from the timer unit 106 and, at Step S111 implemented next, determines whether or not a predetermined period of time has elapsed based on the time obtained at Step S110.

For example, at Step S110, the determining unit 102 obtains the time measured by the timer unit 106 with reference to the point of time of initialization of the timer unit 106 at Step S100. If the time obtained by the timer unit 106 indicates the time after every predetermined automatic capturing period, then the determining unit 102 determines that a predetermined period of time has elapsed. As an example, when the automatic capturing period is set to 10 seconds, if the time obtained at Step S110 indicates the time equal to the sequential addition of the automatic capturing period such as 10 seconds, 20 seconds, 30 seconds, and so on; then the determining unit 102 determines that the predetermined period of time has elapsed.

Meanwhile, herein although the automatic capturing period is set to 10 seconds, that is not the only possible case. That is, as long as the automatic capturing period is longer than the threshold period Tₜₕ, it can be set to be longer than 10 seconds or it can be set to be about few seconds.

At Step S111, when it is determined that the predetermined period of time has elapsed (Yes at Step S111 the system control returns to Step S105. At Step S105, in an identical manner to the explanation given earlier, the display control unit 101 captures the current screen 120 and associates the captured image with the timing of capturing the captured image.

On the other hand, at Step S111, when it is determined that the predetermined period of time has not elapsed (No at Step S111), the system control returns to Step S101.

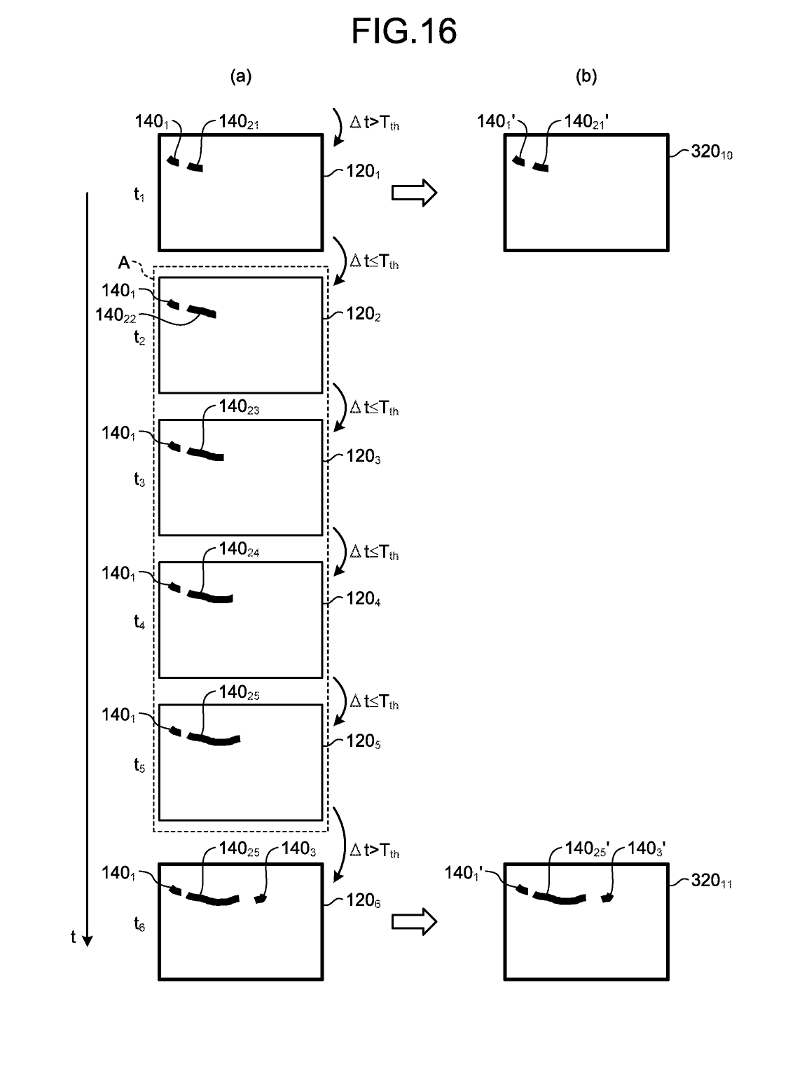

In FIG. 16 is schematically illustrated an example of the screens of the electronic blackboard 10 and the terminal device 30a that are updated according to the operations illustrated in the flowchart in FIG. 15. Herein, for the purpose of illustration, the example of the screens is given for the timings t₁ to t₆ illustrated in FIG. 13.

In a section (a) of FIG. 16, the changes in the screen 120 of the electronic blackboard 10 occurring at the timings t₁ to t₆ are illustrated as screens 120₁ to 120₆, respectively. In a section (b) of FIG. 16 is schematically illustrated an example of the screen of the terminal device 30a to which the images of the screen 120 of the electronic blackboard 10 are transferred.

In the section (a) of FIG. 16, the screens 120₁ to 120₅ are identical to the screens 120₁ to 120₅ illustrated in the section (a) of FIG. 14. In that case, regarding the timing t₁ and the timing t₂, regarding the timing t₂ and the timing t₃, regarding the timing t₃ and the timing t₄, and regarding the timing t₄ and the timing t₅; the time difference Δt is equal to or smaller than the period Tₜₕ. For that reason, in the flowchart illustrated in FIG. 15, according to the determination performed by the determining unit 102 at Step S104, the system control returns to Step S101 and neither the screen 120 of the electronic blackboard 10 is captured nor the updating of the screen according to the screen 120 is performed in the terminal device 30a.

Meanwhile, regarding the timing t₅ and the timing t₆, the time difference Δt exceeds the period Tₜₕ. Hence, according to the determination performed by the determining unit 102 at Step S104; the system control proceeds to Step S105 and, in the electronic blackboard 10, the display control unit 101 captures the current screen 120₆. Then, the captured image is sent to the terminal device 30a and, as illustrated by a screen 320₁₁ in FIG. 16(b), the screen of the terminal device 30a is updated according to the screen 120₆ of the electronic blackboard 10.

In the example illustrated in the section) of FIG. 16, in the screen 320₁₁; the images 140₁, 140₂₅, and 140₃ are reflected as images 140₁′, 140₂₅′, and 140₃′, respectively.

Meanwhile, the screens 120₂ to 120₅ that are illustrated in a dotted frame in the section (a) of FIG. 16 are not captured, and thus no captured images thereof are sent to the terminal device 30a. In the terminal device 30a, for example, a screen 320₁₀ is displayed during the period when the screens 120₂ to 120₅ are displayed in the electronic blackboard 10, and the screen 320₁₀ is updated to the screen 320₁₁ in accordance with the timing at which the screen 120₆ gets displayed in the electronic blackboard 10.

Meanwhile, in the section (a) of FIG. 16, the time difference Δt between the timing t₁ and the event acquisition timing obtained at Step S103 in the previous loop (for example, the timing t₀) exceeds the period Tₜₕ. For that reason, in an identical manner to the case of the timing t₆ described earlier, the screen 120₁ gets captured in the electronic blackboard 10 and, due to the captured image, the screen of the terminal device 30a gets updated to the screen 320₁₀ illustrated in the section (b) of FIG. 16.

In the example illustrated in the section (b) of FIG. 16, the images 140₁, 140₂₅, and 140₃ that are drawn on the screen 120₆ of the electronic blackboard 10 are reflected as the images 140₁′, 140₂₅′, and 140₃′, respectively, in the screen 320₁₁ of the terminal device 30a.

In this way, in the display control system 1 according to the first embodiment, when a drawing event is generated in the first operation mode, if a different drawing event has not been generated within a period of time traced back for the period Tₜₕ from the time of generation of the concerned drawing event, the electronic blackboard 10 captures the screen 120. However, if a different drawing event has been generated during that period of time, then the electronic blackboard 10 does not capture the screen 120.

Thus, when drawing is being performed in succession, the screen 120 is not captured. When the drawing is discontinued, the screen 120 is captured. Hence, the user of the terminal device 30a becomes able to skip the process of drawing and view only a certain result of the drawing.

Moreover, in the display control system 1 according to the first embodiment, capturing the screen 120 of the electronic blackboard 10 and sending the captured image to the terminal device 30a are performed when the drawing on the screen 120 is discontinued; and thus the image data indicating the process of drawing is not sent to the terminal device 30a. That enables achieving reduction in the traffic in the network 40.

Moreover, the termination of drawing for at least a certain period of time (the period Tₜₕ) in the electronic blackboard 10 sometimes indicates the compartmentalization of thoughts of the person performing the drawing. Hence, even if the terminal device 30a is present at a remote location from the installation position of the electronic blackboard 10, the user of the terminal device 30a can interpret the flow of thoughts of the person performing the drawing.

Meanwhile, in the explanation given above, the screen of the terminal device 30a is updated according to the images captured at Step S105. However, that is not the only possible case. For example, the images captured at Step S105 can be reduced and can be displayed as the reduced images 1240₁, 1240₂, 1240₃, and 1240₄ in the timeline area 124 in chronological order.

Moreover, in the explanation given above, at Step S104, although the determination is performed with the single period Tₜₕ serving as the threshold value; that is not the only possible case. Alternatively, for example, the determination operation at Step S104 can be performed using a plurality of threshold values that correspond to the types of drawing event determined to have been obtained at Step S101. For example, it is possible to think of a case in which the drawing events include events of drawing on the screen 120 and events of erasing the images drawn on the screen 120. Thus, the period Tₜₕ set as the threshold value is set to have different values for the events of drawing and for the events of erasing. For example, it is possible to think of setting the period Tₜₕ for the events of erasing to be longer than the period Tₜₕ for the events of drawing.

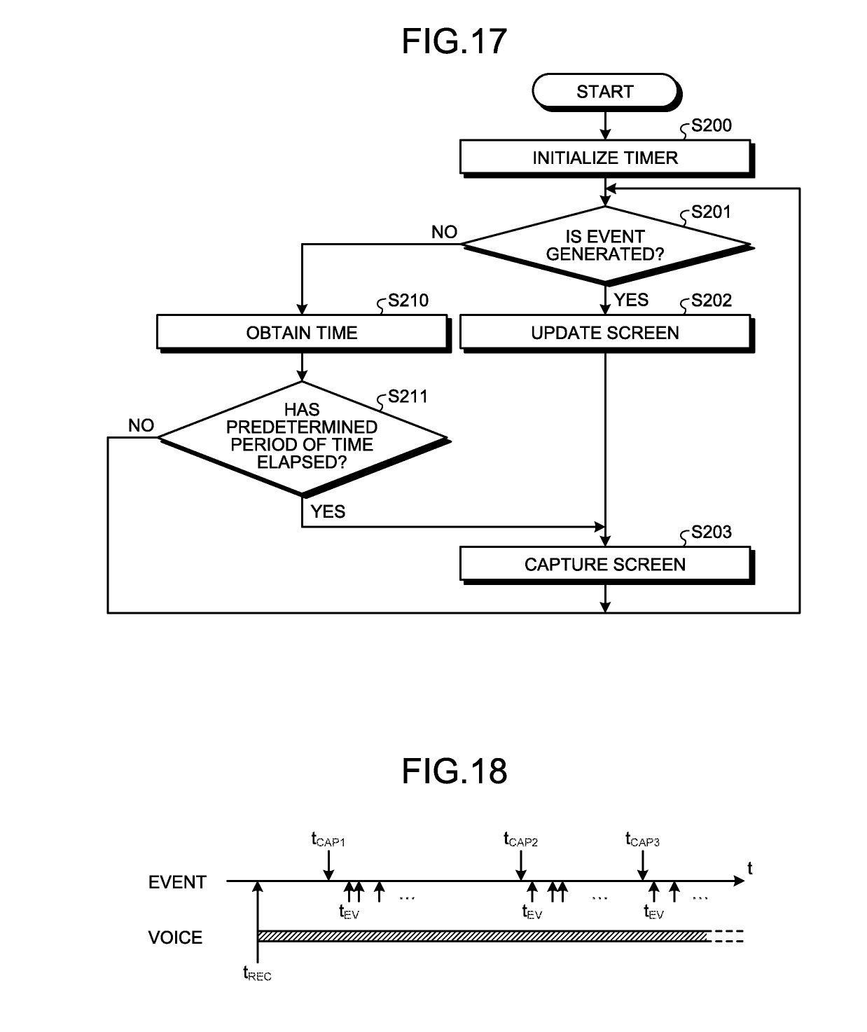

Given below is the explanation of the screen capturing performed in the second operation mode of the electronic blackboard 10. FIG. 17 is a flowchart for explaining an example of the control performed regarding the screen capturing in the second operation mode of the electronic blackboard 10. The operations illustrated in the flowchart in FIG. 17 are started when the operation mode of the electronic blackboard 10 switches to the second operation mode. At Step S200, the electronic blackboard 10 initializes the timer unit 106 and makes the timer unit 106 measure the amount of time from the initial value.

The operations from Step S201 onward are repeatedly performed in a loop until the operation mode of the electronic blackboard 10 switches from the second operation mode to the first operation mode.

At Step S201 implemented next, the display control unit 101 determines whether or not the input detecting unit 100 has generated any event in response to an input with respect to the touch-sensitive panel 1007. If it is determined that an event is generated (Yes at Step S201), then the system control proceeds to Step S202. At Step S202, the display control unit 101 updates the display on the screen 120 according to the event generated by the input detecting unit 100.

At Step S203 implemented next, the display control unit 101 captures the current screen 120. Then, according to the operation at Step S11 illustrated in FIG. 2, the display control unit 101 sends the captured image obtained by capturing the screen 120 to the server device 20, as well as stores the captured image in the storage 1003, for example. When the operation at Step S203 is completed, the system control returns to Step S201.

The server device 20 sends the captured image, which is captured at Step S203 and which is sent from the electronic blackboard 10, to the terminal device 30a (Step S13 illustrated in FIG. 2). Upon receiving the captured image sent from the server device 20, the terminal device 30a updates the screen thereof with the captured image that is received (Step S15 illustrated in FIG. 2).

Meanwhile, at Step S201, if it is determined that no event is generated (No at Step S201), then the system control proceeds to Step S210. The operations performed at Steps S210 and S211 are identical to the operations performed at Steps S110 and S111, respectively, illustrated in the flowchart in FIG. 15.

That is, at Step S210, the determining unit 102 obtains the current time from the timer unit 106 and, at Step S211 implemented next, determines whether or not a predetermined period of time has elapsed based on the time obtained at Step S210. At Step S211, when it is determined that the predetermined period of time has elapsed (Yes at Step S211), the system control returns to Step S203. On the other hand, at Step S211, when it is determined that the predetermined period of time has not elapsed (No at Step S211), the system control returns to Step S201.

Audio Recording Operation According to First Embodiment

As explained earlier, the electronic blackboard 10 according to the first embodiment includes the microphone 1011 and the voice I/F 1008. For example, when the button 1227 is operated in the screen 120, it becomes possible to record the voice picked up by the microphone 1011. The electronic blackboard 10 according to the first embodiment can perform audio recording of the voice independent of the capturing of the screen 120.

In FIG. 18 is illustrated an exemplary relationship between audio recording and screen capturing performed in the electronic blackboard 10 according to the first embodiment. For example, in the first operation mode, the detection of a drawing event and the capturing of the screen 120 is performed according to the flowchart illustrated in FIG. 15. In the upper part in FIG. 18, the generation of drawing events is illustrated as timings t_{EV}; while the capturing of the screen 120 is illustrated as timings t_{CAP1}, t_{CAP2}, t_{CAP3}, and so on. Herein, the timings t_{Ev} represent examples of the timings of drawing events at which the drawing events are obtained within the period Tₜₕ at Step S104 illustrated in FIG. 15 and at which the screen 120 is updated without it being captured.

Meanwhile, in the electronic blackboard 10, in response to the detection by the input detecting unit 100 of an operation of the button 1227, the voice processing unit 105 starts the audio recording of digital voice signals that are based on the voice picked up by the microphone 1011. For example, as illustrated in the lower part of FIG. 18, in response to an operation of the button 1227, the audio recording is assumed to start from a timing t_{REC}. The audio recording is continuously performed independent of the detection of drawing events and the capturing of the screen 120 as illustrated in FIG. 18 until, for example, an operation for instructing the termination of audio recording is detected by the input detecting unit 100.

### Second Embodiment

Given below is the explanation of a second embodiment. In the first embodiment described above, the electronic blackboard 10 controls the capturing of the screen 120 thereof and controls the transmission of the captured images to the terminal device 30a. In contrast, in the second embodiment, the server device 20 controls the transmission of captured images, which are obtained in the electronic blackboard 10, to the terminal device 30a.

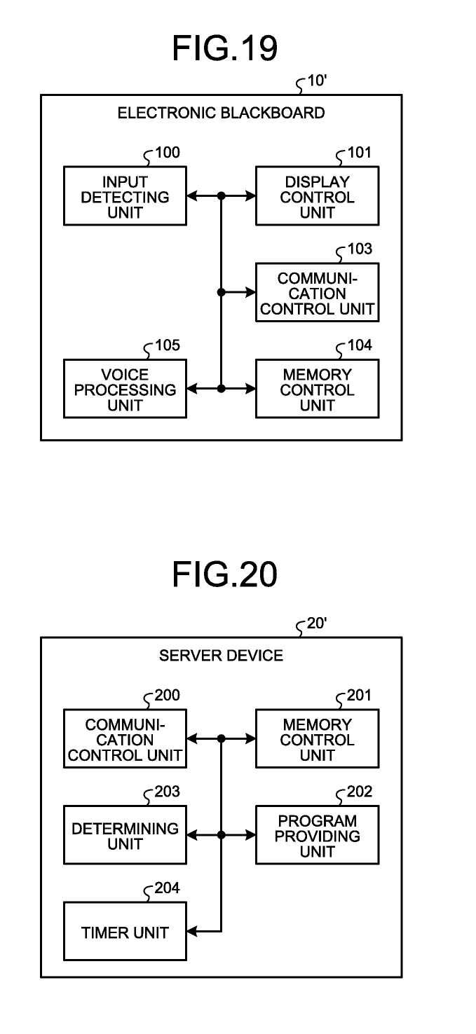

FIG. 19 is a functional block diagram of an example meant for explaining the functions of an electronic blackboard 10′ according to the second embodiment. With reference to FIG. 19, the same constituent elements as illustrated in FIG. 6 are referred to by the same reference numerals, and the detailed explanation of those constituent elements is not repeated. With reference to FIG. 19, as compared to the electronic blackboard 10 illustrated in FIG. 6, the electronic blackboard 10′ implementable in the second embodiment does not include the determining unit 102 and the timer unit 106. Thus, in the electronic blackboard 10′, the computer program meant for implementing the functions of the electronic blackboard 10′ (i.e., an electronic blackboard program) too may not have the determining unit 102 and the timer unit 106 unlike the electronic blackboard program according to the first embodiment.

FIG. 20 is a functional block diagram of an example meant for explaining the functions of a server device 20′ according the second embodiment. With reference to FIG. 20, the same constituent elements as illustrated in FIG. 7 are referred to by the same reference numerals and their detailed explanation is not repeated. As illustrated in FIG. 20, as compared to the server device 20 illustrated in FIG. 7, the server device 20′ according to the second embodiment additionally includes a determining unit 203 and includes a timer unit 204 that measures the amount of time and outputs information indicating the measured amount of time as time information.

The determining unit 203 determines, based on a predetermined condition, whether or not to send the captured image, which is sent from the electronic blackboard 10′, to the terminal device 30a. For example, based on the time information associated to the captured image sent from the electronic blackboard 10′ and based on the amount of time measured by the timer unit 204, the determining unit 203 determines whether or not to send the captured image to the terminal device 30a.

Meanwhile, in the second embodiment, as far as the overall configuration of the display control system is concerned, it is possible to have an equivalent configuration to the display control system 1 explained with reference to FIGS. 1 and 2. Hence, the detailed explanation of the configuration is not repeated. Moreover, also regarding the electronic blackboard 10′, the server device 20′, and the terminal devices 30a, 30b, and so on; the configuration of the electronic blackboard 10, the server device 20, and the terminal device 30a explained with reference to FIGS. 3 to 5 can be implemented without modification. Hence, the detailed explanation thereof is not repeated.

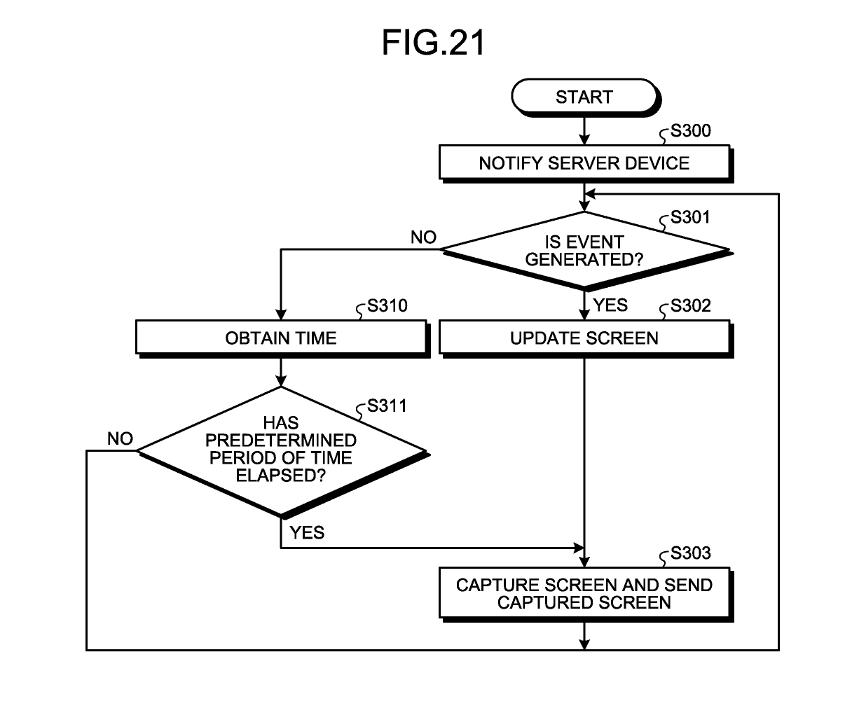

FIG. 21 is a flowchart for explaining an example of the control performed regarding the screen capturing by the electronic blackboard 10′ according to the second embodiment. The operations illustrated in the flowchart in FIG. 21 are implementable in the first operation mode as well as in the second operation mode of the electronic blackboard 10′.

At Step S300, for example, when the electronic blackboard program is activated and the screen 120 is displayed, the communication control unit 103 of the electronic blackboard 10′ sends a notification about the activation of the electronic blackboard program to the server device 20′.

At Step S301 implemented next, in the electronic blackboard 10′, the display control unit 101 determines whether or not the input detecting unit 100 has generated any event in response to an input with respect to the touch-sensitive panel 1007. If it is determined that an event is generated (Yes at Step S301), then the system control proceeds to Step S302. At Step S302, in the electronic blackboard 10′, the display control unit 101 updates the display on the screen 120 according to the event generated by the input detecting unit 100.

At Step S303 implemented next, in the electronic blackboard 10′, the display control unit 101 captures the current screen 120. When the screen 120 is captured, the electronic blackboard 10′ sends the captured image having the timing of capturing associated thereto to the server device 20, and stores the captured image having the timing of capturing associated thereto in the storage 1003, for example. When the operation at Step S303 is completed, the system control returns to Step S301.

Meanwhile, at Step. S301, if it is determined that no event is generated (No at Step S301), then the system control proceeds to Step S310. The operations performed at Steps S310 and S311 are substantially identical to the operations performed at Steps S110 and S111, respectively, illustrated in the flowchart in FIG. 15.

That is, at Step S310, in the electronic blackboard 10′, for example, the display control unit 101 obtains the current time and, at Step S311 implemented next, determines whether or not a predetermined period of time has elapsed based on the time obtained at Step S310. In this case too, in an identical manner to Step S105 illustrated in FIG. 15, if the obtained time indicates the time after every predetermined automatic capturing period, then it is determined that the predetermined period of time has elapsed. At Step S311, when it is determined that the predetermined period of time has elapsed (Yes at Step S311), the system control returns to Step S303 at which the electronic blackboard 10′ captures the screen 120 and sends the captured image.

On the other hand, at Step S311, when it is determined that the predetermined period of time has not elapsed (No at Step S311), the system control returns to Step S301.

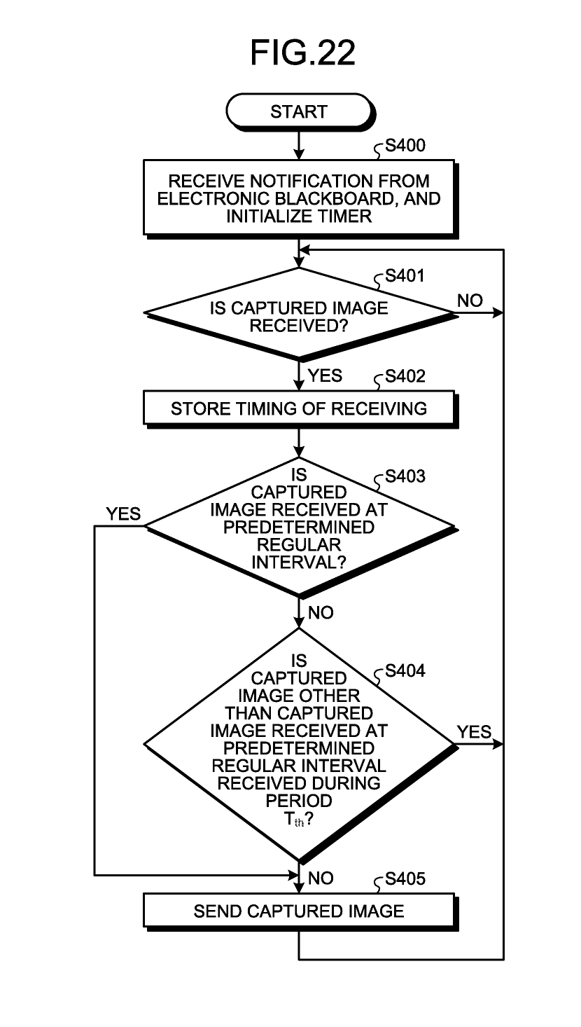

FIG. 22 is a flowchart for explaining an example of the operations performed in the server device 20′ according to the second embodiment. At Step S400, the server device 20′ receives a notification from the electronic blackboard 10′ about the transmission done at Step S300 illustrated in FIG. 21. Upon receiving the notification at Step S400, the server device 20′ initializes the timer unit 204 and makes the timer unit 204 measure the amount of time from the initial value. When the operation at Step S400 is completed, the system control proceeds to Step S401.

The subsequent operations from Steps S401 to S405 are performed in a loop until, for example, the reception from the electronic blackboard 10′ of a notification of ending the operations according to the electronic blackboard program.

At Step S401, in the server device 20′, the communication control unit 200 determines whether or not a captured image is received from the electronic blackboard 10′. If it is determined that a captured image is not received (No at Step S401), then the system control returns to Step S401. On the other hand, if it is determined that a captured image is received. (Yes at Step S401), then the system control proceeds to Step S402.

At Step S402, the electronic blackboard 10′ obtains the timing of receiving the captured image and stores the obtained timing in, for example, the storage 1003 or the RAM 1002. However, that is not the only possible case. Alternatively, the electronic blackboard 10′ can obtain the timing associated to the captured image. Moreover, in the server device 20′, the memory control unit 201 associates the received captured image with the timing obtained at Step S402, and stores the captured image in the storage 2003 (Step S14 illustrated in FIG. 2).

At Step S403 implemented next, based on the timing obtained at Step S402, the determining unit 203 in the server device 20′ determines whether or not the captured image that is received is an image captured at a predetermined regular interval, that is, captured after a predetermined automatic capturing period. For example, when the difference between the timing obtained at Step S402 in the previous loop and the timing obtained at Step S402 implemented one step before matches with the predetermined period of time set as the automatic capturing period, the determining unit 203 determines that the capturing is done after every predetermined regular interval.

If it is determined that the captured image that is received is not captured at the predetermined regular interval (No at Step S403), then the system control proceeds to Step S404. On the other hand, if it is determined that the captured image that is received is captured at the predetermined regular interval (Yes at Step S403), then the system control proceeds to Step S405.

At Step S404, the determining unit 203 in the server device 20′ determines whether or not a captured image other than the captured image received at the predetermined regular interval, that is, other than the captured image received at the predetermined automatic captured period is received from the electronic blackboard 10′ during the period Tₜₕ, which is set in advance as the threshold value, from the current timing. When it is determined that such another captured image is received (Yes at Step S404), the system control returns to Step S401. On the other hand, when it is determined that no such another captured image is received (No at Step S404), the system control proceeds to Step S405.

The operation performed at Step S404 is explained in a more specific manner. At Step S404, the determining unit 203 obtains the difference Δt between the timing obtained and stored at Step S402 of the previous loop and the event acquisition timing obtained and stored at Step S402 implemented one step before, and determines whether or not the difference Δt exceeds the period Tₜₕ. At Step S404, if the difference Δt is equal to or smaller than the period Tₜₕ, then the server device 20′ determines that the other captured image, which is other than the captured image obtained at the predetermine regular interval, has been received from the electronic blackboard 10′ within the period Tₜₕ from the event acquisition timing. On the other hand, if the difference Δt exceeds the period Tₜₕ, then the server device 20′ determines that the captured image obtained at the predetermine regular interval has not been received from the electronic blackboard 10′ within the period. Tₜₕ from the event acquisition timing.

At Step S405, the server device 20′ sends the captured image, which is received at Step S401, to the terminal device 30a according to, for example, Step S13 illustrated in FIG. 2. Upon receiving the captured image sent from the server device 20, the terminal device 30a updates the screen thereof with the captured image that is received (Step S15 illustrated in FIG. 2).

In this way, within the period of time traced back for the period. Tₜₕ from the timing of reception of the captured image, when no other captured image is received except for the automatically captured image that is captured at the predetermined regular interval, the server device 20′ according to the second embodiment sends the captured image that is received to the terminal device 30a. On the other hand, within the period of time traced back for the period. Tₜₕ from the timing of reception of the captured image, when some other captured image is received in addition to the automatically captured image that is captured at the predetermined regular interval, the server device 20′ according to the second embodiment does not send the concerned captured image that is received to the terminal device 30a.

Thus, for example, when drawing is being performed in succession in the electronic blackboard 10′, no captured image is sent to the terminal device 30a. When the drawing is discontinued, a captured image is sent to the terminal device 30a. For that reason, in an identical manner to the explanation given with reference to FIGS. 16(a) and 16(b), the user of the terminal device 30a becomes able to skip the process of drawing and view only a certain result of the drawing.

The exemplary embodiments provide a display control system, a display control method, and a display device as mentioned previously. In addition, the exemplary embodiments can also provide an information processing device comprising an information processing device capable of connecting a display device and a terminal device, comprising: circuitry configured to obtain, in response to updating of screen of the display device, obtain image of the screen; update, in response to updating of the screen of the display device, screen of the terminal device according to contents of the screen of the display device; and determine, when the circuitry obtains the image, whether or not difference between a first timing, at which the image is obtained, and a second timing, which corresponds to timing at which the circuitry obtained the image in previous instance, is exceeding a setting time period that is set in advance, wherein, when the circuitry determines that the difference is equal to or smaller than the setting time period, the circuitry does not update the screen of the terminal device.

According to the embodiments, updating of the screen according to the user operations can be done at more appropriate timings.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A display control system comprising:
circuitry configured to:
detect a user operation meant for updating a first screen;
update, in response to updating of the first screen, a second screen according to contents of the first screen; and
determine, when the circuitry detects the user operation, whether or not difference between a first timing, at which the user operation is detected, and a second timing, which corresponds to timing at which the circuitry detected the user operation in previous instance, is exceeding a setting time period that is set in advance, wherein
when the circuitry determines that the difference is equal to or smaller than the setting time period, the circuitry does not update the second screen.

2. The display control system according to claim 1, wherein
when the circuitry determines that the difference is exceeding the setting time period, the circuitry updates the second screen according to the first screen displayed at the first timing.

3. The display control system according to claim 1, wherein
the user operation includes a first user operation of updating the first screen according to a first method and a second user operation of updating the first screen according to a second method, and
depending on whether the user operation detected by the circuitry is the first user operation or the second user operation, the circuitry performs determination according to the setting time period that is different.

4. The display control system according to claim 1, wherein
the user operation includes a user operation performed in a first operation mode in which a drawing operation with respect to the first screen is accepted and includes a user operation performed in a second operation mode in which the drawing operation with respect to the first screen is not accepted, and
when the user operation is a user operation performed in the second operation mode, the circuitry does not perform the determination.

5. The display control system according to claim 1, wherein
when the circuitry determines that the difference is exceeding the setting time period, the circuitry stores, in a memory medium, an image of the first screen, which is displayed at the first timing, in a corresponding manner to the first timing.

6. The display control system according to claim 5, wherein
the circuitry displays, on at least either the first screen or the second screen, the images, which are stored in the memory medium, one by one in chronological order based on the first timings associated to the images.

7. The display control system according to claim 1, wherein
the circuitry further updates the second screen with contents of the first screen over a longer time interval than the setting time period.

8. The display control system according to claim 1, wherein
the circuitry further obtains ongoingly voice regardless of whether or not the circuitry has detected the user operation.

9. A display control method comprising:
detecting a user operation meant for updating a first screen;
controlling that includes updating, in response to updating of the first screen, a second screen according to contents of the first screen; and
determining that, when the user operation is detected at the detecting, includes determining whether or not difference between a first timing, at which the user operation is detected, and a second timing, which corresponds to timing at which the user operation was detected at the detecting in previous instance, is exceeding a setting time period that is set in advance, wherein
when it is determined at the determining that the difference is equal to or smaller than the setting time period, the controlling includes not updating the second screen.

10. The display control method according to claim 9, wherein
when the determining determines that the difference is exceeding the setting time period, the controlling updates the second screen according to the first screen displayed at the first timing.

11. The display control method according to claim 9, wherein
the user operation includes a first user operation of updating the first screen according to a first method and a second user operation of updating the first screen according to a second method, and
depending on whether the user operation detected by the detecting is the first user operation or the second user operation, the determining performs determination according to the setting time period that is different.

12. The display control method according to claim 9, wherein
the user operation includes a user operation performed in a first operation mode in which a drawing operation with respect to the first screen is accepted and includes a user operation performed in a second operation mode in which the drawing operation with respect to the first screen is not accepted, and
when the user operation is a user operation performed in the second operation mode, the determining does not perform the determination.

13. The display control method according to claim 9, further comprising storing, when the determining determines that the difference is exceeding the setting time period, in a memory medium, an image of the first screen, which is displayed at the first timing, in a corresponding manner to the first timing.

14. The display control method according to claim 13, wherein
the controlling displays, on at least either the first screen or the second screen, the images, which are stored in the memory medium, one by one in chronological order based on the first timings associated to the images.

15. The display control method according to claim. 9, wherein
the controlling further updates the second screen with contents of the first screen over a longer time interval than the setting time period.

16. The display control method according to claim 9, further comprising obtaining ongoingly voice regardless of whether or not the detecting has detected the user operation.

17. A display device comprising:
circuitry configured to:
detect a user operation meant for updating a first screen;
obtain, in response to updating of the first screen, image of the first screen; and
determine, when the circuitry detects the user operation, whether or not difference between a first timing, at which the user operation is detected, and a second timing, which corresponds to timing at which the circuitry detected the user operation in previous instance, is exceeding a setting time period that is set in advance, wherein
when the circuitry determines that the difference is equal to or smaller than the setting time period, the circuitry does not obtain the image.
